(19) United States
(12) Patent Application Publication
(10) Pub. No.: US 2019/0050780 A1
(43) Pub. Date: Feb. 14, 2019

(54) SYSTEM FOR DYNAMICALLY CALIBRATING INTERNAL BUSINESS PROCESSES WITH RESPECT TO REGULATORY COMPLIANCE AND RELATED BUSINESS REQUIREMENTS

(71) Applicant: INFRONT COMPLIANCE, INC., Orlando, FL (US)

(72) Inventors: Melissa Koch, Orlando, FL (US); Alia Luria, Orlando, FL (US); Martin Michalak, Orlando, FL (US)

(21) Appl. No.: 16/059,782

(22) Filed: Aug. 9, 2018

Related U.S. Application Data
(60) Provisional application No. 62/543,615, filed on Aug. 10, 2017.

(51) Int. Cl. G06Q 10/06; G06F 17/30

(52) U.S. Cl. CPC G06Q 10/06393; G06F 17/30654; G06F 17/30719

(57) ABSTRACT

A system for calibrating internal business processes individually or with respect to vendor processes with external vendors in relation to compliance requirements includes at least one processor and a memory communicatively coupled to the at least one processor. The processor is configured to transmit a request for organizational data based on at least one compliance requirement over a network to a remote computer device, where the at least one compliance requirement is stored in a database comprising the microprocessor and the memory that stores the requirements. The processor is also configured to receive a response set for the organization data that is dynamically generated based on answers to dependent questions over the network into the database, and select particular data from the organization to determine compliance of the dynamically generated response set with the at least one compliance requirement.

### RELATED APPLICATION

The present invention is related to U.S. Provisional Patent Application Ser. No. 62/543,615 filed Aug. 10, 2017, the entire contents of which are incorporated herein by reference.

### TECHNICAL FIELD

The present invention relates to the field of compliance, and, more particularly, to a system and method for calibrating internal business processes individually or with respect to vendor processes in relation to compliance requirements, regulatory or otherwise.

### BACKGROUND

Business organizations and their vendors are required to adhere to a plethora of compliance requirements that are set by government and various regulatory bodies as well as internal and external controls. The organizations and their vendors are subject to compliance taking a variety of forms of regulation from an assortment of regulatory bodies as well as customer requirements and operating standards. In addition, compliance requirements are increasing in both scope and penalties causing a precarious operating environment for the organizations and their vendors. Regulators and customers are taking tougher actions against non-compliance by imposing huge penalties, liability, loss of business, and causing potential loss of reputation for a non-compliant party even if such non-compliance was unintentional. Moreover, organizations are responsible not only for their internal compliance efforts, they are also responsible for the compliance efforts of their vendors.

As a result, organizations and their vendors are forced to incur substantial costs and extend significant resources to manage compliance. Moreover, the compliance requirements are dynamic and are subject to change. In fact, there are over 200 daily changes in regulatory rules in the financial services industry alone. The impact of compliance requirements has placed a very large time, cost and risk burden on organizations and has substantially slowed down the pace of contracting. Accordingly, there is a need in the art for a system and method that can address this burden for organizations and their vendors to understand, manage and comply with compliance requirements.

### SUMMARY

In view of the foregoing background, it is therefore an object of the present invention to reduce the burden on organizations and vendors to comply with regulatory and other compliance program requirements. A computer implemented method for dynamically calibrating internal business processes individually or with respect to vendor processes in relation to regulatory compliance and related business requirements is disclosed. The method includes transmitting a request for organizational data based on at least one compliance requirement over a network to a remote computer device, where requirements of the at least one compliance requirement is stored in a database comprising a microprocessor and a memory that stores the requirement. The method also includes receiving a response set for the organization data that is dynamically generated based on answers to dependent questions over the network into the database, and selecting particular data from the organization data to determine compliance of the dynamically generated response set with the compliance requirement, where the organization data comprises a plurality of internal business processes within the organization.

The method may also include an application programming interface (API) configured to access or receive a plurality of universal resource locators (URL) or other data feeds over the network corresponding to a plurality of compliance frameworks, respectively, to detect when a new or modified set of requirements is published for a respective compliance framework, and retrieving the new set of requirements over the network from the respective compliance framework into the database that stores the new or modified set of requirements when the new or modified set of requirements is detected.

The method may include transmitting a delegation, response, substantiation and/or authorization request to the remote computer device for the organization with respect to at least one portion of the response for the organizational data, sharing the output of the request with one or more particular responsible party within the organization, and comparing the response relative to the compliance requirement and/or with a plurality of responses and/or compliance requirements.

In addition, the method may include generating a report to illustrate the organizational compliance relative to at least one compliance requirement, and selecting particular data from the organization data to compare for compliance to the requirements of related business requirements.

The method may also include transmitting a request for vendor data and processes based on the at least one compliance requirement over the network to a vendor remote computer device, where the vendor data comprises a plurality of external vendor processes. The method may include receiving at least one response for the vendor data over the network into the database, selecting particular data from the vendor data to compare for compliance to the requirements of the at least one compliance requirement, and calibrating the external vendor's response relative to the compliance requirement(s). Also, the method may include transmitting a customer request for organizational data based on at least one customer compliance requirement over the network to the remote computer device for the organization.

In another aspect, a system for dynamically calibrating internal business processes with external vendors with respect to regulatory compliance and related business requirements is disclosed. The system includes at least one processor, and a memory communicatively coupled to the at least one processor. The processor is configured to transmit a request for organizational data based on at least one compliance requirement over a network to a remote computer device, where requirements of the at least one compliance requirement is stored in a database comprising the microprocessor and the memory that stores the requirement. The processor is also configured to receive a response for the organization data that is dynamically generated based on answers to dependent questions over the network into the database and compare this dynamically generated response set to the requirements of the at least one compliance requirement.

In another aspect, a non-transitory computer readable medium for operating a server that is part of a computing system comprising at least one computing device for dynamically calibrating internal business processes with external vendors with respect to regulatory compliance and related business requirements is disclosed. The non-transitory computer readable medium includes a plurality of computer executable instructions for causing the server to perform steps comprising transmitting a request for organizational data based on at least one compliance requirement, where the organization data comprising a plurality of internal business processes. In addition, the non-transitory computer readable medium includes receiving a response set for the organization data that is dynamically generated based on answers to dependent questions, and selecting particular data from the organization data to compare for compliance of the dynamically generated response set to the requirements of the at least one compliance requirement.

### BRIEF DESCRIPTION OF THE DRAWINGS

FIG. 1 is a general flowchart of a method of dynamically calibrating internal business processes with respect to compliance requirements in which various aspects of the disclosure may be implemented;

FIG. 2 is a general flowchart of a method of dynamically calibrating internal business processes of external vendors in which various aspects of the disclosure may be implemented;

FIG. 3 is a general flowchart of a method for retrieving a new or modified set of requirements from the respective compliance framework to update a database in which various aspects of the disclosure may be implemented;

FIG. 4 is a general diagram of a system incorporating a microprocessor and a memory in which the system and method of FIGS. 1-3 may be used;

FIG. 5 is a screen shot of a user interface in which various aspects of the disclosure may be implemented;

FIG. 6 is a screen shot of the user interface of FIG. 5 with a General IT Security module selected;

FIG. 7 is a screen shot of the General IT Security module being launched with the user interface of FIG. 5;

FIG. 8 is a screen shot of the General IT Security module requesting exemplary organizational data;

FIG. 9 is a screen shot illustrating a user providing the exemplary organizational data to the General IT Security module;

FIG. 10 is a screen shot of the General IT Security module requesting additional organizational data;

FIG. 11 is a screen shot of an exemplary Module Report generated from the organization data collected by the General IT Security Module;

FIG. 12 is a screen shot of exemplary recommendations as a result of a calibration of the organizational data with compliance requirements;

FIG. 13 is a screen shot of an exemplary display indicating a stage of completion of various sections of the General IT Security module;

FIG. 14 is a screen shot of a summary of responses from the General IT Security module;

FIG. 15 is a screen shot of a user interface indicating modules requested by the customer for compliance;

FIG. 16 is a screen shot of a user interface of a summary of vendors and respective number of modules required for compliance;

FIG. 17 is a screen shot of the user interface of FIG. 16 illustrating which modules are required for compliance by the respective vendor;

FIG. 18 is a screen shot of a user interface to add a vendor in order to request compliance with particular modules;

FIG. 19 is a screen shot of the user interface of FIG. 18 illustrating dragging a module from a module library over to the vendor; and

FIG. 20 is a screen shot of the user interface of FIG. 18 illustrating the modules selected for compliance by the vendor.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention includes a method and system that uses automated means to create an expert, updateable and customizable process for calibrating and establishing internal business and external vendor compliance across regulatory and internal business control frameworks. In a particular aspect, the method and system codifies single and various regulatory requirement frameworks (e.g., the Health Insurance Portability and Accountability Act (“HIPAA”), the Gramm-Leach-Bliley Act (“GLB”), Financial Industry Regulatory Authority (“FINRA”), Occupational Safety and Health Administration (“OSHA”), the Sarbanes-Oxley Act (“SOX”), etc.) and other business compliance requirements (e.g., safety, environmental, corporate social responsibility, etc.) to eliminate manual responses, inefficiencies, outdatedness and errors.

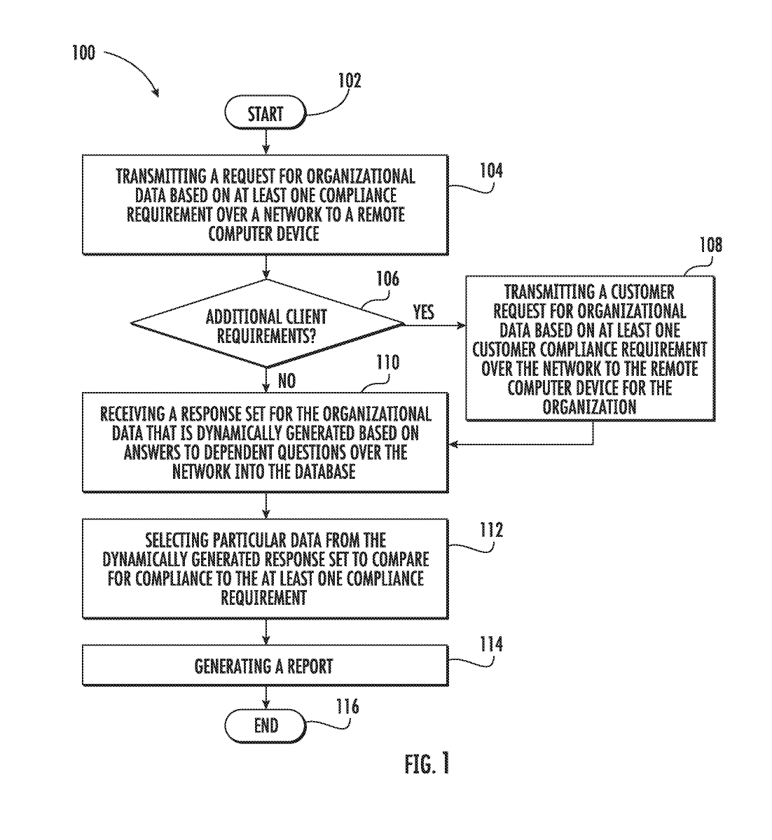

Referring now to FIG. 1 is a general flowchart of a method 100 of dynamically calibrating internal business processes with respect to compliance requirements in which various aspects of the disclosure may be implemented. At 102, the method begins where a request for organizational data based on at least one compliance requirement is transmitted over a network to a remote computer device, at 104.

If there are additional customer requirements determined at 106, then a customer request for organizational data based on at least one customer compliance requirement is transmitted, at 108, over the network to the remote computer device for the organization. Moving to 110, a response set for the organizational data that is dynamically generated based on answers to dependent questions is received over the network into the database. This dynamically generated response set is, at 112, compared for compliance to the at least one compliance requirement. A report, at 114, is generated and the method ends at 116.

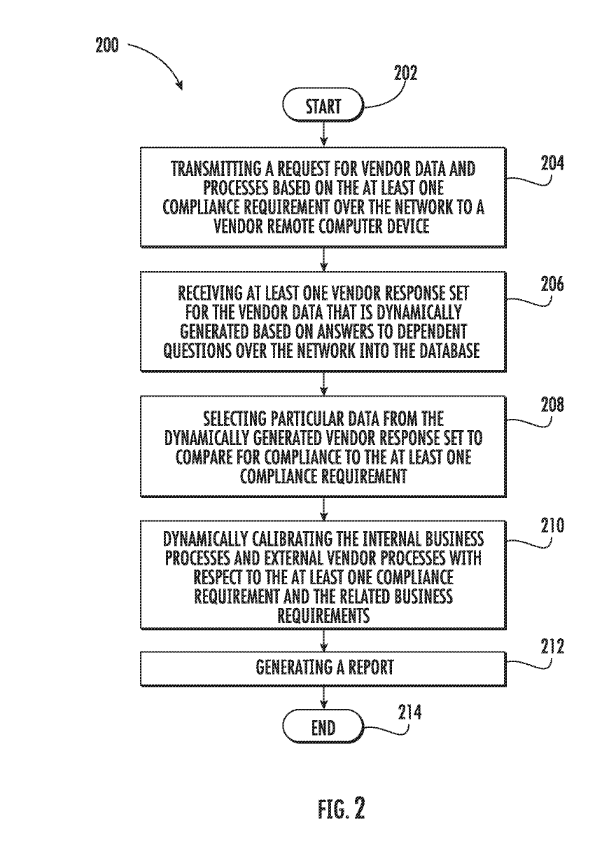

FIG. 2 is a general flowchart of a method 200 of dynamically calibrating internal business processes of external vendors in which various aspects of the disclosure may be implemented. The method 200 begins at 202 where a request for vendor data and processes based on the at least one compliance requirement is transmitted, at 204, over the network to a vendor remote computer device. A response set for the vendor data that is dynamically generated based on answers to dependent questions is received, at 206, over the network into the database. This dynamically generated response set, at 208, of the vendor data is compared for compliance to the at least one compliance requirement. Moving to 210, the internal business processes and external business processes are dynamically calibrated to compliance requirements. A report is generated, at 212, and the method ends at 214.

In a particular aspect, machine learning may be implemented to learn respective compliance requirements in order to determine whether responses indicate compliance for the same or similar requirement in a separate compliance framework. For example, the machine learning aspect may be configured to learn words and phrases that indicate compliance with a particular regulation of a respective regulatory requirement after receiving a response to a substantively similar regulatory requirement formatted differently for another regulation.

The requirements may be updateable at the question, section, module or stack level with additional customizable fields, as needed. The method and system can be applied to existing vendors and internal processes as well as qualifying and managing new vendors and proposed business processes. The method and system includes automated summary and detailed reporting to enable visibility into compliance performance, and also includes automated notification and re-certification processes and exception reporting to determine, track, compare and benchmark ongoing compliance.

Referring now to FIG. 3, a general flowchart of a method 300 for retrieving a new set of requirements from the respective compliance program to update a database is illustrated. The method 300 begins at 302 where a plurality of universal resource locators (URL) are accessed, at 304, with an application programming interface (API) over the network corresponding to a plurality of compliance programs. At 306, if a new set of requirements published are detected, then the new set of requirements, at 308, are automatically retrieved over the network from the respective compliance program. The new set of requirements, at 310, are stored in the database when the new set of requirements is detected in real-time and the method ends at 312.

In addition, a mechanism may be included to link to static or live screen verifications to substantiate compliance statements or perform remote audits. Further, the method and system may be configured to share, track and capture responses to compliance questions from the appropriate internal and external stakeholders.

The system may include a hosted computing environment having a plurality of modules and groups of modules (referred to herein as stacks). For example, the system may include one or more discrete screening modules comprised of several qualifying questions each to determine the types and categories of information being collected, processed, stored, handled, transmitted or otherwise accessed, and using the dynamic logic aspect to determine if and to what extent a specific regulatory framework(s) apply, with the option to skip such screening module(s) if elected by the end user.

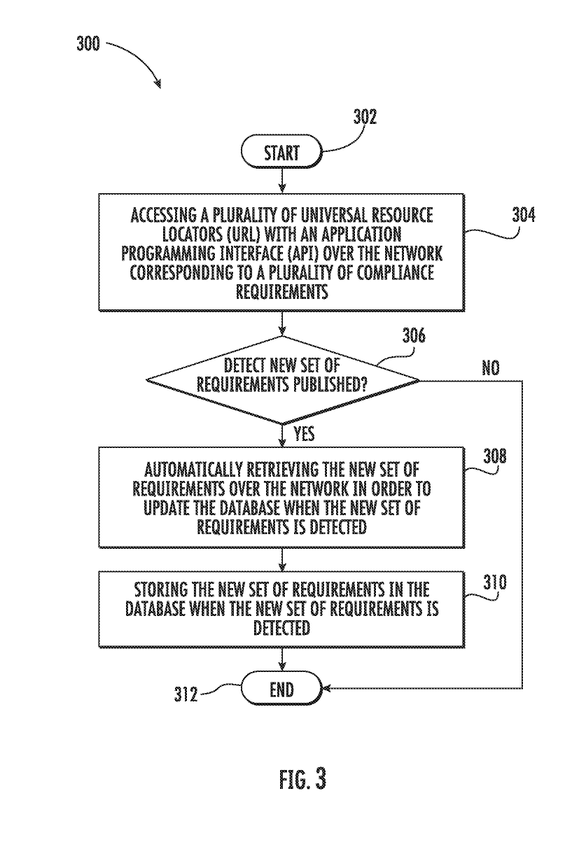

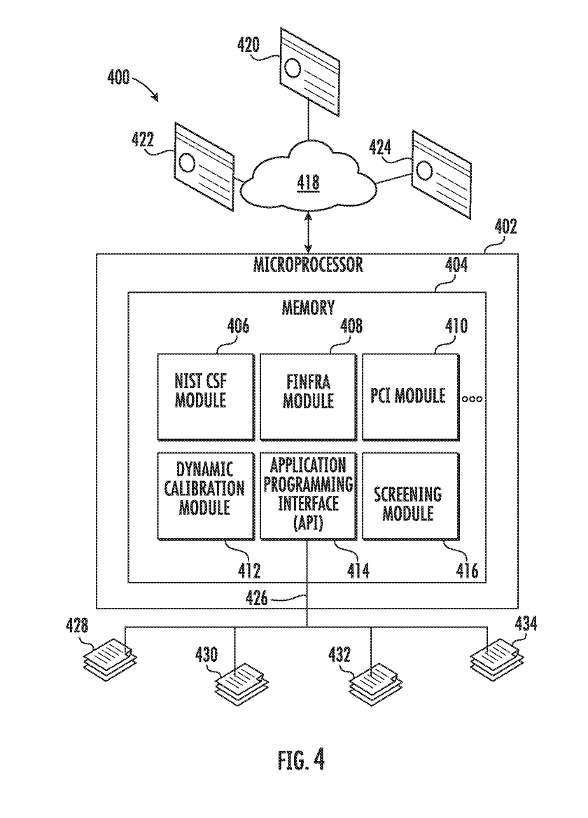

Referring now to FIG. 4, is a general diagram of a system 400, which includes a microprocessor 402 and a memory 404. The memory 404 is used to store modules such as a NIST CSF Module 406, a FINFRA Module 408, a PCI Module 410, a Dynamic Calibration Module 412, and a Screening Module 416, for example. In addition, an application programming interface (API) 414 may be stored in memory.

The user interface 420, vendor interface 422, and customer interface 424 are generated by the microprocessor 402 and transmitted via the cloud 418 or other network. The API 414 is in communication with a plurality of universal resource locators (URL) over a network 426 corresponding to a plurality of compliance programs 428, 430, 432, 434, respectively, to detect when a new set of requirements is published for a respective compliance program.

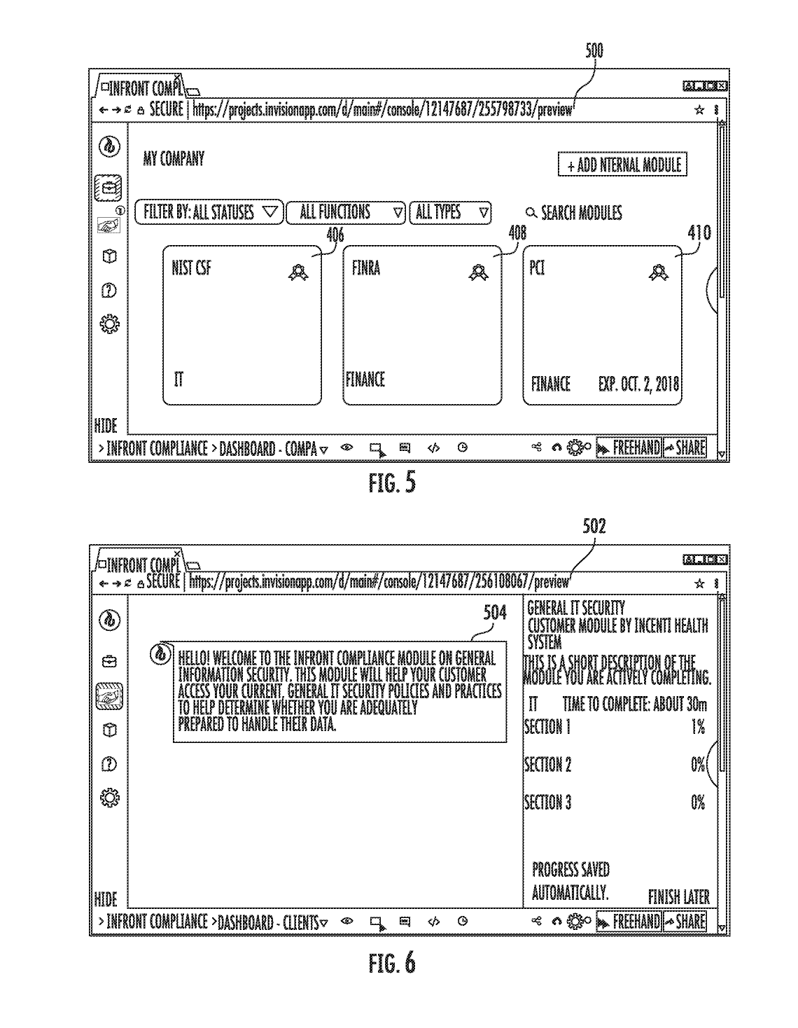

Referring now to FIG. 5, a screen shot of a user interface 500 in which various aspects of the disclosure may be implemented is illustrated. In operation, one or more framework specific modules 406, 408, 410 may include questions based on the compliance framework requirements and guidelines, and be configured to provide affirmative, negative and in process responses answers in various forms including without limitation “yes”, “no” and “in process” with text boxes for further description of status or plans to come into compliance. As explained above, machine learning may be implemented to learn whether the responses to the questions indicate compliance with that or other respective compliance framework requirements and guidelines.

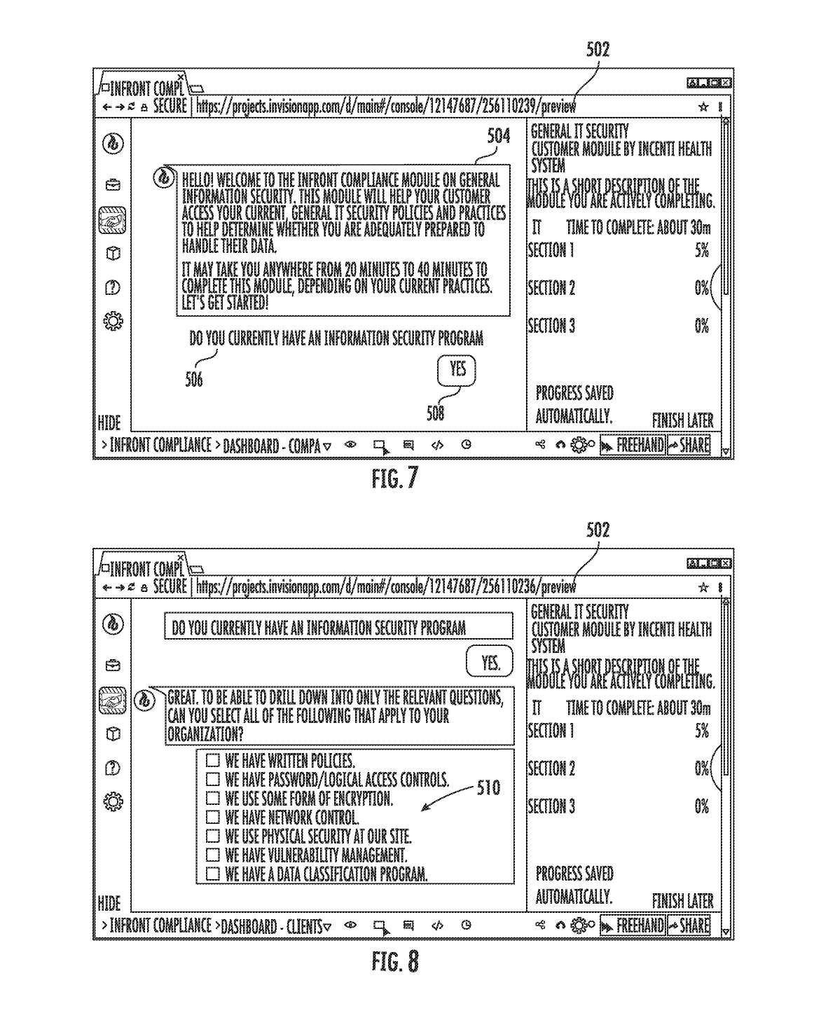

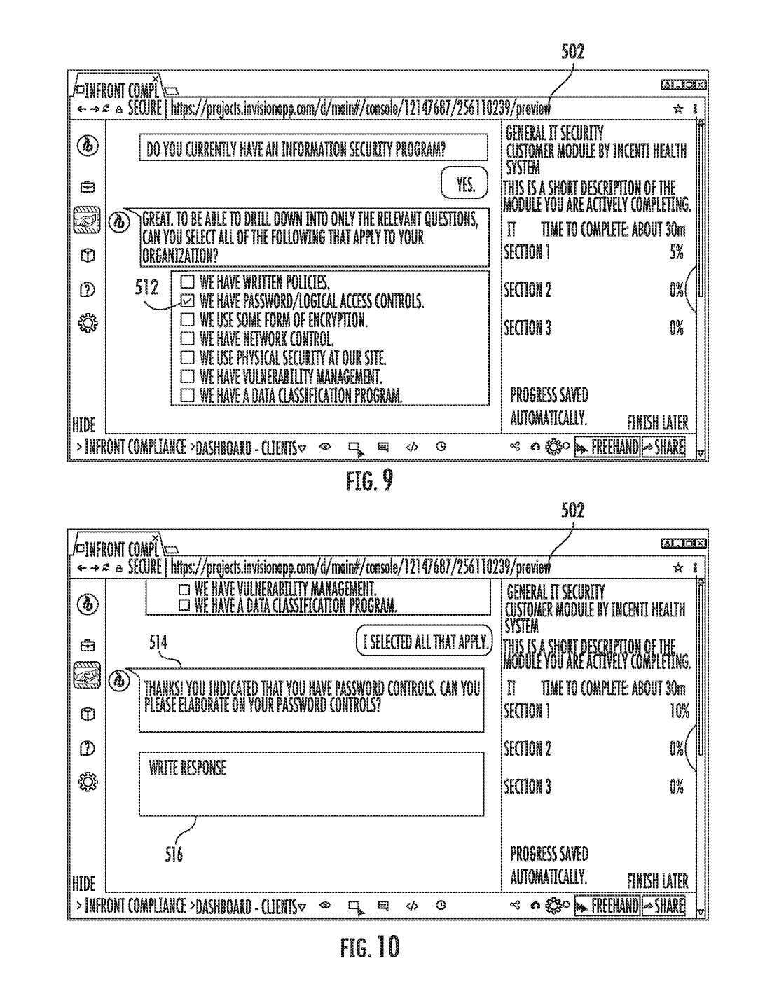

For example, the General IT Security module has been selected in FIG. 6 and an initial greeting 504 is displayed on initiation of the module. Organizational data is then collected through a series of specific questions 506, as illustrated in FIG. 7, that are used subsequently to determine compliance with the respective compliance requirements. Some questions may lead to other questions 510 as illustrated in FIG. 8. The appropriate responses 512 are selected, as shown in FIG. 9, and in some cases, further elaboration 514 may be requested and a text box 516 deployed in order to collect additional specific information as illustrated in FIG. 10.

In the event a specific question or questions in a module requires a response from a particular stakeholder (e.g., responsible party within the organization), that question or questions is transmitted to such stakeholder(s) and the method and system is configured to track and capture responses.

Each specific module may be configured to be qualitatively analyzed such that if a particular question under a framework is responsive to a question under a different framework, the method and system is configured to identify that both questions under both modules are consistent, and the responder to the question will not need to provide duplicate answers. In other words, if a requirement under FINRA is the same as a requirement under SOX, the machine learning aspect of the system and method is configured to recognize the response as applicable to both frameworks and the response will only need to be answered one time. These may be identified herein as “common requirements.”

Each specific module may be configured to include common requirements, as well as requirements particular to those mandated or otherwise recommended under such specific module's framework. Should a common requirement change over time, the method and system is configured to be updated and evaluated to determine whether a prior response remains adequate or if re-certification is necessary.

In addition to framework requirements, the method and system is configured so that an organization may also add its own additional requirements to a regulatory framework module or create its own module for internal compliance purposes. An organization may do this by adding its own requirements with regard to a particular regulatory framework module or establishing its own internal business control module (e.g., for environmental, safety or CSR compliance) and have the vendor or internal company functions respond to such modules to measure compliance levels. In addition, customizations may be made at the question, section, module or stack levels.

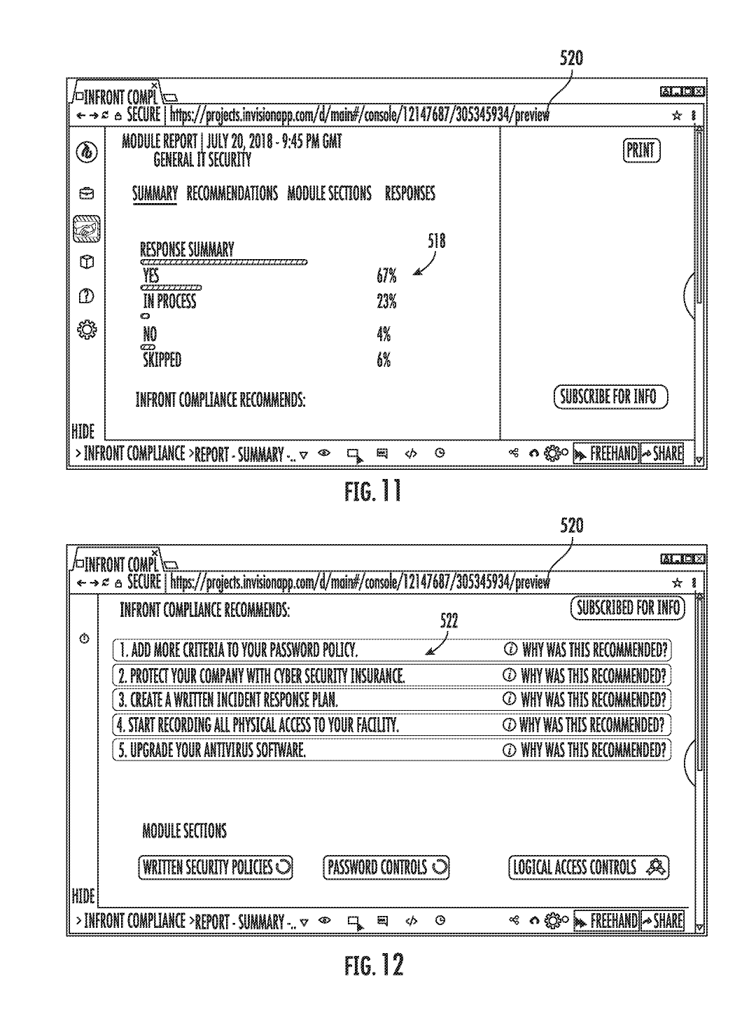

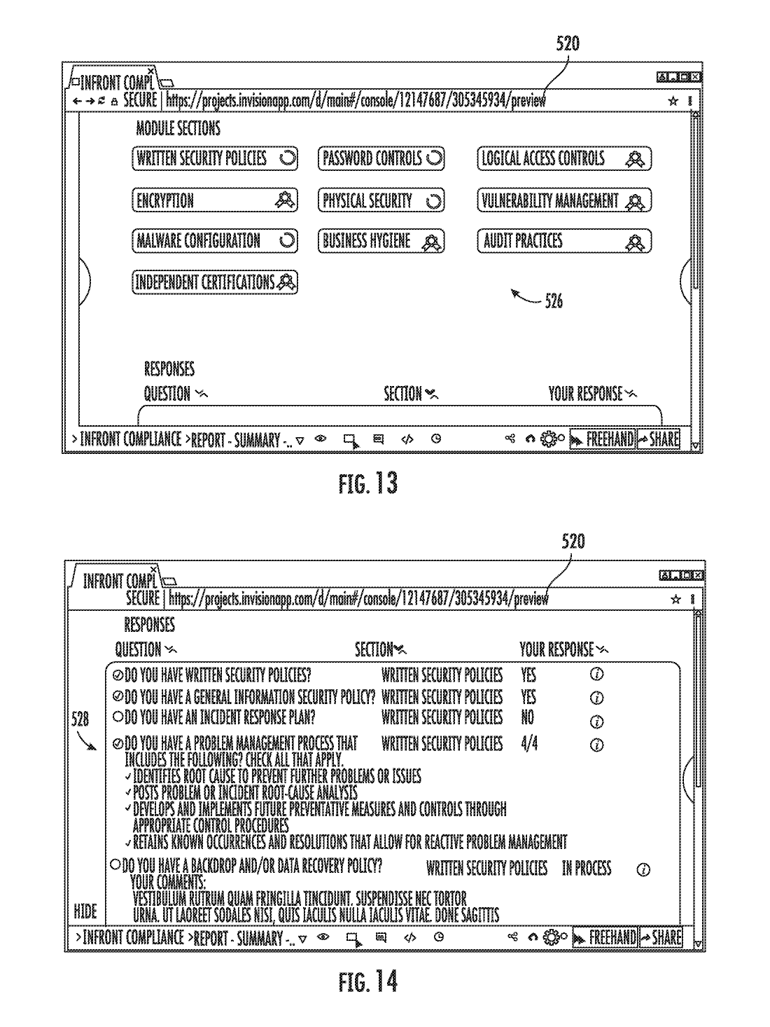

Referring now to FIGS. 11-14, the method and system may be configured to generate reports 520 as shown in FIG. 11, which is a screen shot of an exemplary report 520 generated from the organization data collected by the General IT Security Module. Scorecard reports 520 may provide a summary of progress 518 of the module, specific framework compliance scoring, which may include, without limitation, areas of deficiency 522, and/or a listing of the answers that included additional text responses. For example, recommendations 522 may also be generated dynamically as shown in FIG. 12, which is a screen shot of exemplary recommendations 522 as a result of a calibration of the organizational data with compliance requirements. FIG. 13 is a screen shot of an exemplary display indicating a stage of completion 526 of various sections of the General IT Security module and FIG. 14 is a screen shot of a summary of responses 528 from the General IT Security module.

The report 520 may also indicate which additional frameworks a vendor would be compliant with, or have gap items with, in addition to the framework for which the vendor completed the process. For example, if a vendor provided responses to the FINRA module, the summary report 520 may also show if and to what extent additional requirements would be necessary to comply with SOX requirements.

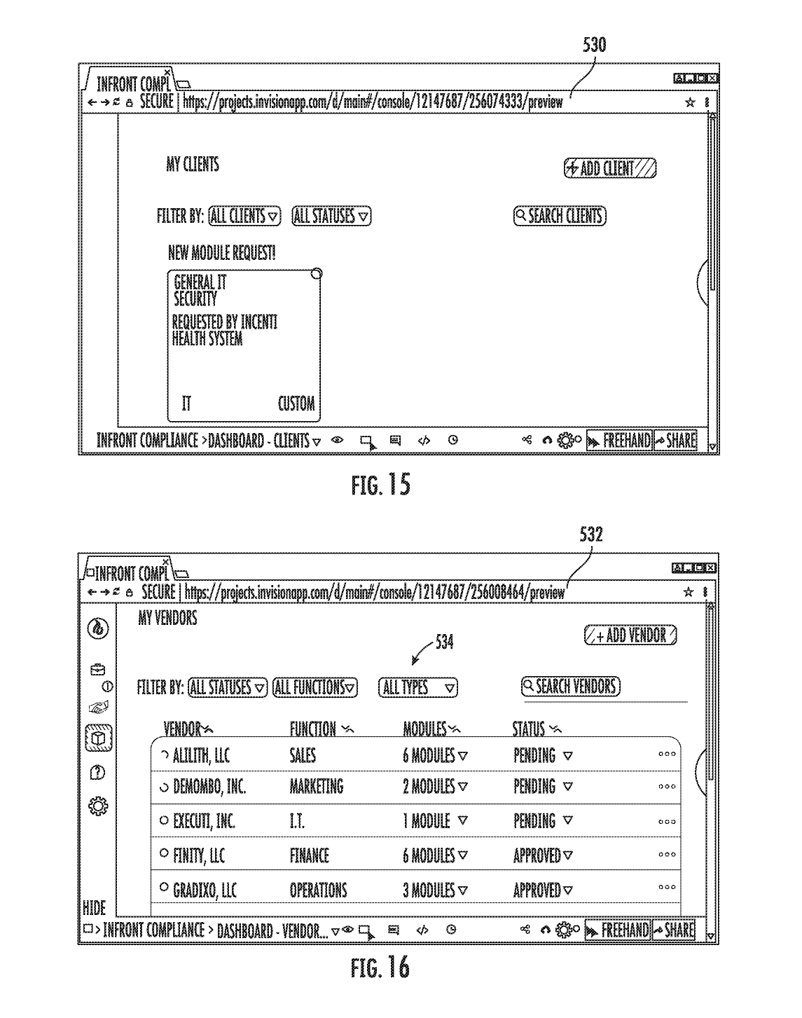

In addition, customers may have specific modules that are necessary for compliance in addition to internal business requirements for the organization. For example, in FIG. 15, which is a screen shot of a user interface 530, the customer has requested compliance with the General IT Security module.

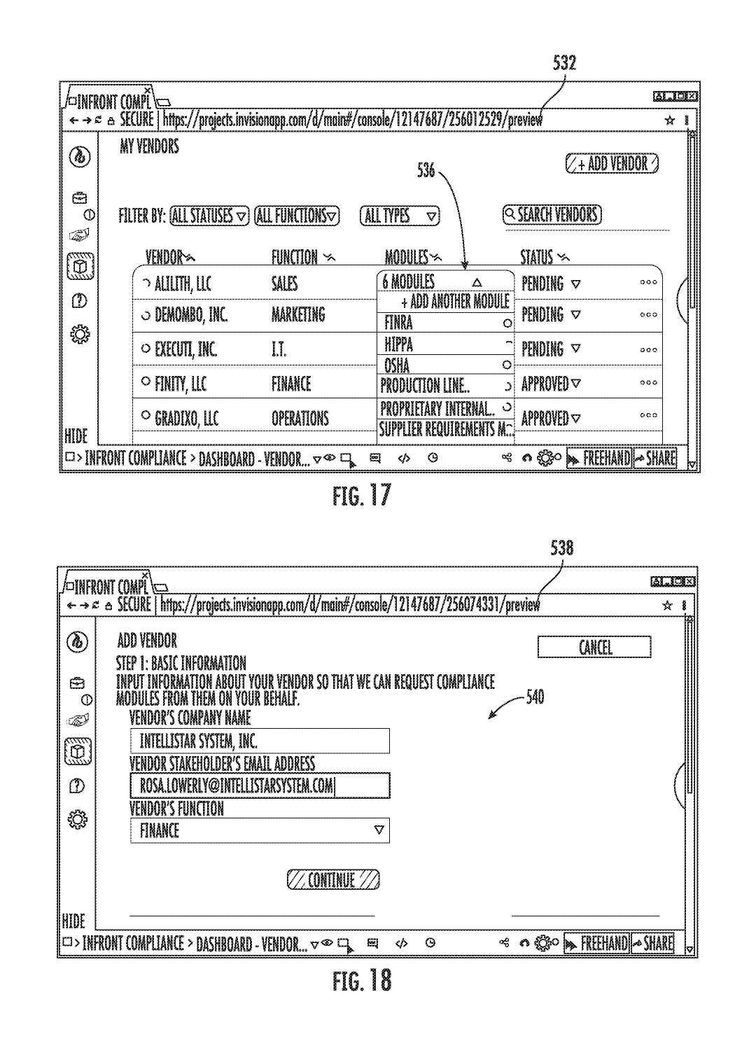

Referring now to FIG. 16, a screen shot of a user interface 532 of a summary of vendors 534 and respective number of modules required for compliance is illustrated. FIG. 17 is a screen shot of the user interface 532 of FIG. 16 illustrating which modules 536 are required for compliance by the respective vendor. These requirements can also be assembled into a stack which could adjust using dynamic logic to display relevant questions based on prior responses.

FIG. 18 is a screen shot of a user interface 538 to add a vendor 540 in order to request compliance with particular modules. The method and system may generate a report for those vendors undertaking the process for purposes of proactive compliance, where the report details affirmative responses, negative responses, and gap areas identified to come into compliance. Where a vendor has completed the process, and is in compliance, the method and system will generate for that vendor a self-certification notification which may remain effective for a certain period of time, or until the requirements change.

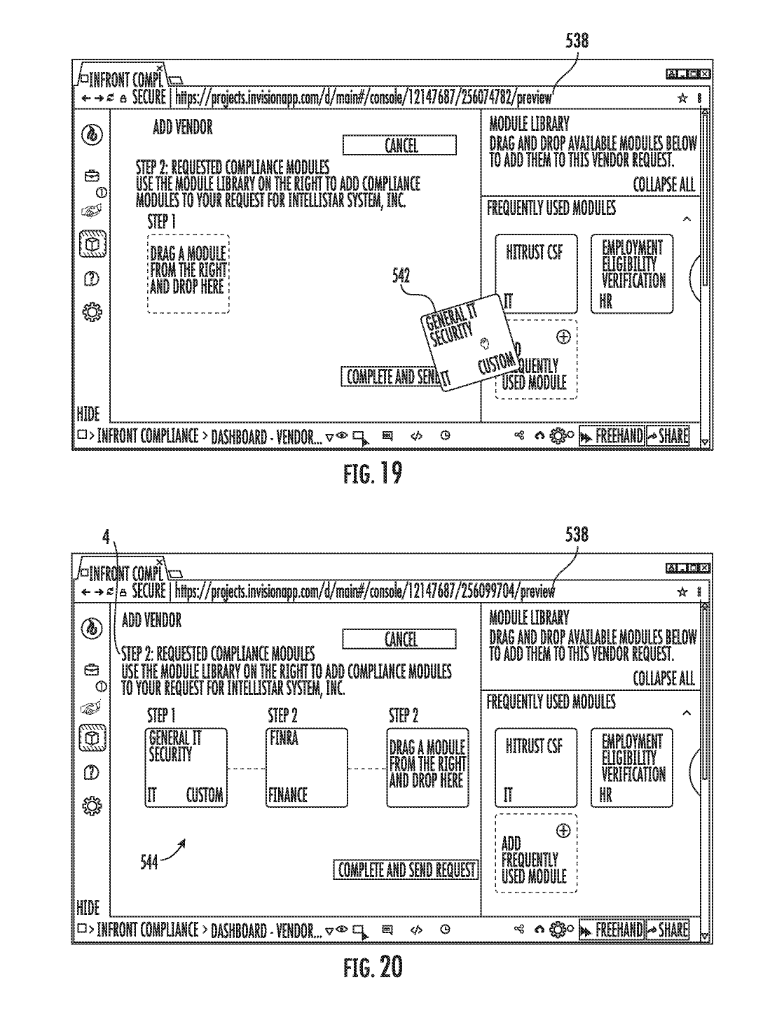

FIG. 19 is a screen shot of the user interface 538 of FIG. 18 illustrating dragging a module 542 from a module library over to the vendor. FIG. 20 is a screen shot of the user interface 538 of FIG. 18 illustrating the modules 544 selected for compliance by the vendor.

For companies and organizations who use the method and system to rank and score vendors, the method and system includes electronically displaying or transmitting a report of the vendor's responses in order to evaluate and determine suitability of that vendor for a particular engagement or evaluate and rank ongoing compliance scores and performance.

The method and system is also configured to generate aggregated reports based on the types and numbers of responses at the time to identify patterns of compliance, patterns of noncompliance, opportunities for improvement, and other analytical purposes.

The following is an example of how the method and system may operate. Company A is subject to both FINRA and SOX requirements with respect to data security and is seeking to bring on a vendor that will have access to Company A's data. Current method of compliance includes typically legal/compliance review of the applicable contract and, if a resource is available, IT review of the data related provisions without certainty of the actual regulatory requirement leading to the possibility of error and non-compliance.

Instead, the method and system is configured to provide Company A with:
an online or API integrated portal enabling Company A to centralize, manage and monitor compliance efforts as determined by Company A;
a screening module configured to determine which and whether a particular compliance framework applies;
automated online hosted vendor questionnaire for each of the applicable or selected frameworks with response capability such as (without limitation) “yes,” “no,” and “other,” responses, with the “other” field accompanied by a text box for more thorough explanation;
the ability to invite vendors to respond to particular sets of modules via code, link or other mode;
response efficiency through identifying overlapping requirements between the FINRA and SOX requirements so those questions only need to be answered one time;
thoroughness and reduction of errors by identifying areas of departure between the FINRA and SOX requirements so that specific requirements relative to each framework are specified and responses collected;
additional, business-specific compliance management as specified by Company A (e.g., add ons to regulatory frameworks or standalone modules at the election of Company A);
automated reporting using dynamic logic configured to show areas of compliance, areas of non-compliance and additional information provided by the vendor that Company A can evaluate;
automated vendor reporting, certification and re-certification at periodic intervals to enable ongoing compliance; and
cross vendor or internal function compliance performance reports and ranking.

From a vendor perspective, the method and system is also configured for a vendor to pre-certify compliance with specific compliance frameworks to reduce or eliminate having to respond to company-specific questionnaires time and time again, saving time and resources. Vendors receive notification of regulatory requirements changes and have the ability to re-certify once the requirements are met, or otherwise on a periodic basis. Vendor responses are self-reported and may be subject to additional manual or automated validation.

By way of example, Vendor A has limited IT and/or compliance and/or legal resources and is in a high growth period. Instead of diverting IT/compliance/legal resources to responding to various and inconsistent customer questionnaires, the method and system is configured to provide Vendor A with:
a portal enabling Vendor A to centralize, manage and monitor compliance efforts as determined by Vendor A;
screening technology to determine which and whether a particular compliance framework applies to Vendor A's activity;
automated questionnaire(s) for each of the applicable or selected frameworks with response capability such as (without limitation) “yes,” “no,” and “other,” responses, with the “other” field accompanied by a text box for more thorough explanation;
response efficiency by identifying overlapping requirements between the applicable requirements so those questions only need to be answered one time;
thoroughness and reduction of errors through identifying areas of departure across multiple compliance framework requirements so that specific requirements relative to each framework are specified and responses collected;
identification of gap areas and suggestions for solutions for coming into compliance;
self-certification, badging or other recognition mechanism for when compliance is achieved for the relevant and applicable period of compliance that can be provided in lieu of a manual questionnaire or certification;
automated notification and/or alerts relating to reporting, certification and re-certification at periodic intervals to enable ongoing compliance.

The method and system is also configured to enable aggregated reporting across all organization requirements and vendor responses by compliance framework, business requirements or other categories which could be used for trend reporting, statistical analysis and solution designs.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A computer implemented method for dynamically calibrating internal business processes individually or with respect to vendor processes with external vendors in relation to compliance requirements, the method comprising:
transmitting a request for organizational data based on at least one compliance requirement over a network to a remote computer device, the at least one compliance requirement being stored in a database comprising a microprocessor and a memory that stores the requirement;
receiving a response set for the organization data that is dynamically generated based on answers to dependent questions over the network into the database; and
selecting particular data from the dynamically generated response set to compare for compliance to the at least one compliance requirement.

2. The computer implemented method of claim 1, wherein the organization data comprises a plurality of internal business processes.

3. The computer implemented method of claim 2 further comprising:
accessing a plurality of universal resource locators (URL) with an application programming interface (API) over the network corresponding to a plurality of compliance requirements, respectively, to detect when a new set of requirements is published for a respective compliance framework; and
automatically retrieving the new set of requirements over the network to update the database that stores the new set of requirements when the new set of requirements is detected.

4. The computer implemented method of claim 2 further comprising transmitting a customer request for organizational data based on at least one customer compliance requirement over the network to the remote computer device for the organization.

5. The computer implemented method of claim 2 further comprising sharing the request for organizational data with a particular responsible party within the organization.

6. The computer implemented method of claim 2 further comprising dynamically calibrating the response for the organizational data with a plurality of compliance requirements for consistency.

7. The computer implemented method of claim 2 further comprising generating a report to illustrate a summary of the organization compliance with the at least one compliance requirement.

8. The computer implemented method of claim 2 further comprising selecting particular data from the organization data to compare for compliance to related business requirements.

9. The computer implemented method of claim 8 further comprising:
transmitting a request for vendor data and processes based on the at least one compliance requirement over the network to a vendor remote computer device, the vendor data comprises a plurality of external vendor processes;
receiving at least one vendor response set for the vendor data that is dynamically generated based on answers to dependent questions over the network into the database;
selecting particular data from the dynamically generated vendor response set to compare for compliance to the at least one compliance requirement; and
dynamically calibrating the internal business processes and external vendor processes with respect to the at least one compliance requirement and the related business requirements.

10. A system for dynamically calibrating internal business processes individually or with respect to vendor processes with external vendors in relation to compliance requirements, the system comprising:
at least one processor; and
a memory communicatively coupled to the at least one processor, the processor configured to
transmit a request for organizational data based on at least one regulatory compliance program over a network to a remote computer device, requirements of the at least one regulatory compliance program being stored in a database comprising the microprocessor and the memory that stores the requirements,
receive a response set for the organization data that is dynamically generated based on answers to dependent questions over the network into the database, and
select particular data from the dynamically generated response set to compare for compliance to the requirements of the at least one compliance requirement.

11. The system of claim 10, wherein the organization data comprises a plurality of internal business processes.

12. The system of claim 11, wherein the processor is further configured to:
access a plurality of universal resource locators (URL) with an application programming interface (API) over the network corresponding to a plurality of compliance frameworks, respectively, to detect when a new set of requirements is published for a respective compliance framework; and
retrieve the new set of requirements over the network from an URL of the respective compliance framework to update the database that stores the new set of requirements when the new set of requirements is detected.

13. The system of claim 11, wherein the processor is further configured to transmit a customer request for organizational data based on at least one customer compliance requirement over the network to the remote computer device for the organization.

14. The system of claim 11, wherein the processor is further configured to share the request for organizational data with a particular responsible party within the organization.

15. The system of claim 11, wherein the processor is further configured to dynamically calibrate the response for the organizational data with a plurality of compliance requirements for consistency.

16. The system of claim 11, wherein the processor is further configured to generate a report to illustrate organizational compliance relative to at least one compliance requirement.

17. The system of claim 11, wherein the processor is further configured to select particular data from the organization data to determine compliance with related business requirements.

18. The system of claim 17, wherein the processor is further configured to transmit a request for vendor data and processes based on the at least one compliance requirement over the network to a vendor remote computer device, the vendor data comprises a plurality of external vendor processes;
receive a vendor response set for the vendor data that is dynamically generated based on answers to dependent questions over the network into the database;
select particular data from the dynamically generated vendor response set to compare for compliance to the at least one compliance requirement; and
dynamically calibrate the internal business processes and external vendor processes with respect to compliance with the at least one compliance requirement and the related business requirements.

19. A non-transitory computer readable medium for operating a server that is part of a computing system comprising at least one computing device for dynamically calibrating internal business processes individually or with respect to vendor processes with external vendors in relation to compliance requirements, and with the non-transitory computer readable medium having a plurality of computer executable instructions for causing the server to perform steps comprising:
transmitting a request for organizational data based on at least one compliance requirement, the organization data comprising a plurality of internal business processes;
receiving a response set for the organization data that is dynamically generated based on answers to dependent questions; and
selecting particular data from the organization data to determine compliance of the dynamically generated response set with the compliance requirement.

20. The non-transitory computer readable medium according to claim 19 further comprising:
transmitting a request for vendor data and processes based on the at least one compliance requirement over the network to a vendor remote computer device, the vendor data comprises a plurality of external vendor processes;
receiving a vendor response set for the vendor data that is dynamically generated based on answers to dependent questions over the network into the database;
selecting particular data from the vendor data to determine compliance of the dynamically generated vendor response set with the at least one compliance requirement; and
dynamically calibrating the internal business processes and external vendor processes with respect to compliance with the at least one compliance requirement and the related business requirements.

21. The non-transitory computer readable medium according to claim 20 further comprising transmitting a customer request for organizational data based on at least one customer compliance requirement over the network to the remote computer device for the organization.
